(19) United States
(12) Patent Application Publication
(10) Pub. No.: US 2008/0118627 A1
(43) Pub. Date: May 22, 2008

(54) Formulations For Liquid Coatings To Deliver Flavor To Food Products

(76) Inventor: Margaret T. Virgallito, Dayton, OH (US)

Correspondence Address: CURATOLO SIDOTI CO., LPA, 24500 CENTER RIDGE ROAD, SUITE 280, CLEVELAND, OH, 44145, US

(21) Appl. No.: 11/665,033

(22) PCT Filed: Sep. 29, 2005
(86) PCT No.: PCT/CH05/00561

§ 371 Date: May 11, 2007

Related U.S. Application Data
(60) Provisional application No. 60/618,828, filed on Oct. 14, 2004.

(51) Int. Cl. A23G 3/00

(52) U.S. Cl. 426/660; 514/54

(57) ABSTRACT

The invention is concerned with improved liquid coating formulations for flavoring of food products. Inventive coatings provide improved slacking, cooking stability, improved flavor intensity, or for dry food products, improved shelf life and stability in liquids. Inventive liquid coating formulations comprise a polymer selected from the group consisting of alginate, carageenan, carboxymethylcellulose, and hydroxypropylmethylcellulose in an amount from about 1% to 20%, one or more surfactants in an amount in an amount of 0.1 to 10%, one or more flavor in a sufficient amount, and water to give 100%.

The invention is concerned with formulations applied as a liquid coating to deliver flavor to food products.

Food products are conventionally flavored by glazes that are applied as a coating and stick to a product. Conventional glazes are based on oil and a high amount of carbohydrate (for example, maltodextrin and starch). These tend to drip off the food substrate during cooking so that most of the flavor is lost, and burn during the grilling process. Conventional glaze systems release a high amount of water during cooking and the food product suffers moisture loss and in consequence shrinks and develops an appearance unappealing to the consumer.

There remains a need for a flavor delivery formulation that has a good adherence of the coating to the food product and a high flavor impact.

Surprisingly we have found that formulations according to the present invention have these characteristics. In particular, when applied in liquid form, they adhere well to the food product during cooking and, if the liquid coating is applied to the frozen product, during slacking.

“Slacking” means the process of gradually warming food from frozen to unfrozen to facilitate even heat penetration during the cooking.

Another advantage of liquid coating formulations according to the invention is that applied as a coating they are able to reduce moisture loss from the food product, particularly from a meat product.

A further advantage is that burning or charring of food products, particularly meat products, is reduced. In contrast to conventional carbohydrate glazes that burn at high temperature cooking applications, some particular coatings according to the present invention have a good stability at high temperatures of 600° F. to 1200° F. used e.g. for broiling applications.

Still another advantage is the reduction in surface adhesion of the food product to the cooking utensil (pot, tray, etc.) during cooking, in particular during broiling, pan frying, roasting and grilling.

Formulations according to the invention comprise a polymer selected from the group consisting of alginate, carageenan, carboxymethylcellulose (CMC), and hydroxypropylmethylcellulose (HPMC) in an amount from about 1% to 20%, preferably 2% to 10%, more preferably 3% to 5%; one or more surfactants in an amount in an amount of 0.1 to 10%, preferably 0.2 to 5%, more preferably 0.25 to 2.5%, most preferably 0.5 to 1.5%; one or more flavor in a sufficient amount, and water to give 100% (all percentages w/w).

In a preferred embodiment, in addition, one or more plasticizers are present in an amount of 0.1 to 10%, preferably 0.2 to 5%, more preferably 0.25 to 2.5%, most preferably 0.5 to 1.5%. Plasticizers are known in the art and include, for example polyhydric alcohols such as glycerine, polyethylene glycol, propylene glycol, sorbitol, maltitol and mannitol. A preferred plasticizer is glycerine.

Formulations according to the invention may contain additional optional ingredients. These ingredients include, for example, additional polymers such as starches and maltodextrins. A too high amount of additional polymers may influence cooking stability negatively and in particular where cooking stability at high temperatures (e.g. grilling or baking) is of interest, a low amount of these additional polymers is preferred. Additional polymers are preferably present in low amounts of less than 5%, preferably less than 2.5%, more preferably less than 1%, most preferably less than 0.5%.

In a preferred embodiment containing additional polymers, 1 to 5% film-forming modified starch, preferably 1 to 2% of a film-forming modified starch, is present.

Optional ingredients further include common food grade excipients such as colors, and functional ingredients such as bitter blockers, sweeteners etc.

An inventive formulation forms an essentially stable solution with little or no phase separation in water. The inventive formulation can be applied to a food product as a coating in a manner known in the art, for example the food product can be dipped into the formulation that is to be coated or the formulation can be sprayed onto the food product or it can be applied using a brush. The food product can be raw or precooked and may be in frozen form.

Food products include all food products that can be coated, for example baker's products or baked goods, biscuit products, pastry products, bread products, bread, cakes, cookies, crackers, donuts, flan, muffins, cereal products, dessert products, confectionery products, chocolates, savory products, processed foods, cooked fruits and vegetable products, meat and meat products, egg products, milk and dairy products, and cheese products. One preferred group of food products are meat products including beef, pork, lamb, and especially poultry, particularly chicken.

In a particular embodiment, the inventive formulation comprises a low molecular weight (LMW) alginate (LMW sodium alginate Manucol® LD) and a high molecular weight (HMW) alginate (HMW sodium alginate Protanal® RF6650), a film forming modified starch (Pure Coat 792 Modified Starch), Polysorbate 80 (Surfactant), and Glycerine (Plasticizer).

Advantageously, the formulation may be applied to food substrates that are in frozen form. Liquid coating formulations of the present invention show a particularly good adherence to frozen products and are stable during slacking with minimal to no loss of the coating.

Useful polymers are alginate, carageenan, carboxymethylcellulose, and hydroxypropylmethylcellulose. From the alginates, low or high molecular weight alginate may be employed. Preferably, low and high molecular weight alginates are mixed to give the desired viscosity. A preferred type of alginate is sodium alginate. For example, LMW sodium alginate Manucol® LD and HMW sodium alginate Protanal® RF6650 may be used.

A particular embodiment concerns dry food products, in particular dry flaked food products such as cereal products for consummation in liquids, in particular in milk. For application with these products, the liquid coating formulation comprises alginate in an amount from about 1% to 20%, preferably 2% to 10%, more preferably 3% to 5%; one or more flavor in a sufficient amount, and water.

Optionally, one or more surfactants are present in an amount in an amount of 0.1 to 10%, preferably 0.2 to 5%, more preferably 0.25 to 2.5%, most preferably 0.5 to 1.5%; and water to give 100% (all percentages w/w).

In a preferred embodiment, in addition, one or more plasticizers are present in an amount of 0.1 to 10%, preferably 0.2 to 5%, more preferably 0.5 to 3%, most preferably 1.5 to 2.5%. Plasticizers are known in the art and include, for example polyhydric alcohols such as glycerine, polyethylene glycol, propylene glycol, sorbitol, maltitol and mannitol. A preferred plasticizer is glycerine.

In another preferred embodiment, in additional, modified starches are present in an amount of 1% to 25%, preferably 15% to 20%.

In a particularly preferred embodiment, additional ingredients include one or more plasticiser, and one or more modified starch, in the amounts specified above.

In a particularly preferred embodiment, the inventive formulations as detailed above contain in addition an artificial sweetener (for example sucralose, saccharin, aspartame, cyclamate, acesulfame) in a sufficient amount.

To dry food products, in particular dry flaked food products such as cereal products, the coating is applied in liquid form by pan coating which is well known in the art to the outside of the cereal (for example puffed corn, corn flakes, bran flakes, cheerios, rice crispies), and excess moisture is dried off. Compared to starch-based or carbohydrate-based coatings for cereals (for example corn syrup), the resulting coated cereal product has a longer shelf life, is crunchy and remains so when exposed liquids such as milk for a longer time.

There now follows a series of non-limiting examples that serve to illustrate the invention.

If not otherwise specified, percentages are determined weight by weight.

### EXAMPLES

### Example 1

### Formulation for a Liquid Coating According to the Present Invention

| Ingredients [gram per 100 gram]: polymers: | |
|---|---|
| Protanal ® RF6650 Sodium Alginate | 0.25 |
| Manucol ® LD Sodium Alginate | 4 |
| Surfactant: | |
| Polyoxyethylene Sorbitan Monooleate (Tween 80 ™) | 1 |
| Plasticiser: Glycerine | 1 |
| Flavor: Flavor Blend (Southwest Oil Soluble Flavor) | 7.5 |
| Water (Deionized) | add 100 |
| Optional ingredients: | |
| Film forming modified starch (Pure Coat 79.2 Modified Starch) | 1.25 |
| N-LOK ® Modified Starch | 0.5 |
| Caramel Color | 0.4 |
| Bitter Blocker (Givaudan Flavors, Cincinnati, USA) | 0.4 |
| Citric Acid | 0.103 |
| Sodium Benzoate | 0.1 |

When employed in the following examples, the formulation is used with all optional ingredients.

Polymers are purchased commercially from the sources as indicated below. Alginates: High molecular weight alginate: Protanal® RF6650 Sodium Alginate (ISP Food ingredients, San Diego, Calif., USA), Low molecular weight alginate: Manucol® LD Sodium Alginate (FMC Biopolymers, Philadelphia, USA); N-LOK® (a low viscosity modified starch), and Ultrasperse Modified Starch (cold water swelling starch derived from corn) (National Starch & Chemical, Bridgewater, N.J., USA).

### Example 2

### Conventional Glaze Formulation, Comparison to Formulation of Example 1

Ingredients Conventional Glaze [Gram per 100 Gram]

| | | |
|---|---|---|
| Vegetable Oil - MCT | 15 | g |
| Potato Maltodextrin | 11.44 | g |
| Carboxymethylcellulose | 0.36 | g |
| Ultradisperse Modified Food Starch | 1.45 | g |
| Silicon Dioxide | 0.026 | g |
| Wood Fired Barbacoa Glaze | 6.724 | g |
| water (Deionized) | add 100 | g |

The glaze is formed by mixing 65 g of de-ionized water, 15 g of MCT oil and 20 g of Wood Fired Barbacoa Glaze to give the formulation above. Wood fired Barbacoa formulation for the glaze has the ingredients as listed below.

Ingredients Wood Fired Barbacoa Formulation for the Conventional Glaze [Gram per 100 Gram]

| | |
|---|---|
| Potato Maltodextrin | 57.2 |
| Carboxymethylcellulose | 1.8 |
| Ultrasperse Modified Food Starch | 7.25 |
| Silicon Dioxide | 0.13 |
| Flavor Blend (Southwest Powder Blend) | 33.62 |

Polymers are purchased commercially as indicated below. Maltodextrin: Maltodextrin De10 and Star Dri® 10 (A. E. Staley Manufacturing Co. , Decatur Ill., USA), Maltrin® M-100 (GPC Grain Processing Group, Iowa, USA); Carbooxy Methyl Cellulose 7LF and Carbooxy Methyl Cellulose 7HF (The Dow Chemical Company, Midland, Mich., USA); Ultradisperse Modified Food Starch: Ultrasperse Modified Starch (cold water swelling starch derived from corn) (National Starch & Chemical, Bridgewater, N.J., USA)

### Example 3

### Comparison of Liquid Coating Formulation and Conventional Glaze

The formulation according to example 1 and the conventional glaze of example 2 (both comprising the same flavor blend) are tested on pre-cooked processed frozen chicken breast as a food substrate. The control is tested without application of any glaze or coating. The following samples contain the formulation as indicated above, except that the percentage of coating or glaze per chicken (w/w) is adjusted as indicated.

| | |
|---|---|
| Formulation ex. 1: | +4.2%, formulation according to example 1, applied |
| | on top |
| Glaze I | +4.2% Conventional glaze, applied on top |
| Glaze II | +10% Conventional glaze, applied on top |
| Glaze III | +10% (applied 5% top and 5% on bottom) |

The frozen food substrate is removed from the freezer and weighed on a balance. The coatings are applied in the amounts as indicated above, and the weights are recorded. The performance of each coating is determined during before, during and after cooking. The substrate is slacked for 3 hours in the refrigerator. The weight is measured after slacking. The substrate is cooked on a Double Flame Broiler, with a cooking dwell time of 2 minutes in the broiler. The weight is measured again after cooking. The substrate is evaluated as regards appearance and flavor delivery.

### Weight Loss After Slacking

As shown in the table below, the formulation according to example 1 has less weight loss during slacking, i.e. the coating according to the invention has a superior adhesion compared to all conventional glaze samples. This applies to the glaze samples used in a commonly used quantity (10% based on weight of the substrate, i.e. chicken), both when applied to the top or top and bottom, and to the glaze sample applied in a quantity which is the same quantity that the formulation of ex. 1 is applied (4.2%). The weight loss in the best glaze sample is still more than double that of the inventive formulation. The weight loss of the latter is comparable to the control where no coating could be lost (0.7%, control 0.3%), therefore almost no coating is lost during slacking when the inventive formulation is used (less than 10%, while the best performing glaze has more than 37%).

TABLE 1

| | | | | | Total | | Total |
|---|---|---|---|---|---|---|---|
| | | | | | weight | Total | Weight |
| | | | | coating | after | Weight | Loss after |
| | Chicken | Chicken + | Coating | applied to | slacking | Loss after | Slacking |
| Sample | [g] | Coating [g] | [g] | chicken [%] | [g] | Slacking [g] | [%] |
| Control | 130.0 | 130.0 | | | 129.5 | 0.4 | 0.3 |
| Formulation | 134.7 | 140.3 | 5.6 | 4.2 | 139.3 | 0.9 | 0.7 |
| ex. 1 | | | | | | | |
| Glaze I | 123.6 | 128.8 | 5.2 | 4.2 | 126.5 | 2.3 | 1.8 |
| Glaze II | 139.4 | 153.3 | 13.9 | 10.0 | 143.8 | 9.5 | 6.2 |
| Glaze III | 136.3 | 149.8 | 13.5 | 9.9 | 141.7 | 8.1 | 5.4 |

TABLE 2

| | expected | | | |
|---|---|---|---|---|
| | chicken | | | |
| | weight after | | | |
| | slacking | expected | | |
| | (based on | chicken | | |
| | control) | slacking | | Loss |
| | without | loss (excl | Loss | Coating |
| Sample | coating | coating) | Coating [g] | [%] |
| Control | | | | |
| Formulation | 134.3 | 0.4 | 0.5 | 9.4 |
| ex. 1 | | | | |
| Glaze I | 123.2 | 0.4 | 1.9 | 37.2 |
| Glaze II | 139.0 | 0.4 | 9.1 | 65.2 |
| Glaze III | 135.9 | 0.4 | 7.7 | 56.7 |

### Weight Loss During Cooking

As shown in the table below, the inventive Formulation loses a percentage comparable to the control during the cooking process (the weight loss of the control is attributed to the loss of moisture from the chicken during the cooking process). All glaze samples have a higher weight loss compared to the control (from 22.5 to 30.9%), i.e. the glaze is lost further during cooking when compared with the situation after slacking.

TABLE 3

| | | | | Total | Total |
|---|---|---|---|---|---|
| | Total | Total | Total | Weight | Weight |
| | Weight | Weight | Weight | Loss | Loss |
| | after | Loss after | Loss after | slacking + | slacking + |
| | cooking | Cooking | Cooking | cooking | cooking |
| Sample | [g] | [g] | [%] | [g] | [%] |
| Control | 110.0 | 19.6 | 15.1 | 20.0 | 15.4 |
| Formulation | 118.6 | 20.7 | 14.9 | 21.7 | 15.4 |
| ex. 1 | | | | | |
| Glaze I | 99.9 | 26.6 | 21.1 | 29.0 | 22.5 |
| Glaze II | 105.9 | 37.9 | 26.3 | 47.4 | 30.9 |
| Glaze III | 116.9 | 24.8 | 17.5 | 32.9 | 22.0 |

### Flavor Intensity

Flavor intensity is judged by a panel of 10 test subjects after cooking. The formulation according to example 1 is found to have a higher flavor impact compared both to the control and to all of the glaze samples.

### Example 4

### Alginate Compared to Other Polymer Materials

Formulations of the polymers are shown in the tables below. All formulations below contain 0.4 g bitter masker, 0.4 g caramel color, 5 g flavor (Southwest), and water (de-ionized) add 100 g.

### Formulations A:

| Polymer: | Percentage in formulation [%]: |
|---|---|
| Modified Starches | 20 |
| Maltodextrins | 30 |
| Tapioca Dextrins and Starches | 20 |
| CMC | 10 |
| HPMC | 10 |
| Carrageenan | 3.5 |
| Pectins | 3.5 |
| Protanal ® RF6650 Sodium Alginate | 3 |
| Propylene Glycol Alginate | 3 |
| Manucol ® LD Sodium Alginate | 10 |

Different maltodextrins, modified starches, Tapiocca dextrins and starches, cellulose polymers and pectins, and carrageenans that are used are listed below. Within these groups, the results obtained were similar.

### Maltodextrins: Maltodextrin De10 and Star Dri® 10 (A. E. Staley Manufacturing Co. , Decatur Ill., USA), Maltrin® M-100 (GPC Grain Processing Group, Iowa, USA);

### Modified Starches: CAPSULE (modified food starch derived from waxy maize), N-LOK® (a low viscosity modified starch), and Ultrasperse Modified Starch (cold water swelling starch derived from corn) (National Starch & Chemical, Bridgewater, N.J., USA);

### Tapiocca Dextrins and Starches: Crystal Tex® 627 Tapiocca Dextrin and Instant Tex® (National Starch & Chemical, Bridgewater, N.J., USA);

Cellulose Polymers: Carbooxy Methyl Cellulose 7LF, Carbooxy Methyl Cellulose 7HF, HPMC E50, HPMC E15, and HPMC K99 (The Dow Chemical Company, Midland, Mich., USA); Pectins: Pectin HM (High Methoxy) Rapid 2 Powder, and Pectin 1460 Powder (Tic Gums, Belcamp, Md., USA);
Carageenans: Gelcarin Carrageenan, NF (former Marine Colloids, now: Cambrex, Rockland, Me., USA), Carrageenan KK-100, CarrageenanMB-16, and Carrageenan SI-100 (alcohol precipitated, cold swelling iota carageenan) (ISITM, Ingredients Solutions Inc., Searsport, USA);
Alginates: High molecular weight alginate: Protanal® RF6650 Sodium Alginate (ISP Food ingredients, San Diego, Calif., USA), Low molecular weight alginate: Manucol® LD Sodium Alginate (FMC Biopolymers, Philadelphia, USA), Propylene Glycol Alginate (ISP Food ingredients, San Diego, Calif., USA).

All formulations “B” contain the ingredients of formulations “A” and in addition 5 g Tween 80. All formulations “C” contain the ingredients of formulations “A” and in addition 5 g Tween 80 and 5 g Glycerin.

Solution stability, cooking stability and flavor impact are evaluated by panelists and rated with values from 1 to 3 as described below. Panelists are randomly chosen and receive the rating information given below as instruction. Sla(king stability, or the adherence of the coating, is determined by weight loss of the coating.

### Solution Stability

Solutions A, B and C are rated visually by 10 randomly chosen panelists as follows:

### 1: Uniformly Dispersed Solution—no separation of phases

### 2: Slight separation of solution, a minimal water layer is separating from the solution

### 3: Phase separation of the solution, non-uniform mixture

### Slacking Stability

The weight of the substrate (chicken breast) and of the coating that is applied to the substrate is recorded from the start to finish, and the loss of the coating is determined as shown above in example 3. The adherence of the coating on the substrate is rated from 1-3 as follows:

1: 0 to 10% loss of coating (good adherence)
2: 11% to 30% loss of coating (acceptable adherence)

### 3: Greater than 30% loss of coating (bad adherence)

### Cooking Stability

Cooking stability is evaluated visually for burned blackened parts by 10 randomly chosen panelists and rated from 1 to 3.

1: <10% of the total surface of the substrate with blackening
2: <50% of the total surface of the substrate with blackening
3: 50-100% of the total surface of the substrate with blackening

### Flavor Impact

The cooked substrate is rated from 1 to 3 by 10 randomly chosen panelists for flavor impact.

### 1: Weak Flavor Impact—Flavor barely discernible

### 2: Medium Flavor Impact—Flavor profile is delivered

### 3: Strong Flavor Impact—Flavor is overpowering

TABLE 4A

| | Solution | Slacking | Cooking | Flavor |
|---|---|---|---|---|
| Polymer formulations A | Stability | Stability | Stability | Impact |
| Modified Starches and | Phase | 3 | 3 | 1 |
| Maltodextrins | separation | | | |
| Tapiocca Dextrins and | Phase | 3 | 2 | 1 |
| Starches | separation | | | |
| Cellulose Polymers | Slight | 2 | 3 | 1 |
| (CMC and HPMC) | Separation | | | |
| Carrageenan | Stable | 2 | 3 | 1 |
| | Solution | | | |
| Pectins | Phase | 2 | 3 | 1 |
| | separation | | | |
| Alginates | Stable | 1-2 | 1 | 1 |
| | Solution | | | |

TABLE 4B

| Polymer formulations B | Solution | Slacking | Cooking | Flavor |
|---|---|---|---|---|
| with Tween 80 | Stability | Stability | Stability | Impact |
| Modified Starches and | Phase | 3 | 3 | 1 |
| Maltodextrins | separation | | | |
| Tapiocca Dextrins and | Phase | 3 | 2 | 1 |
| Starches | separation | | | |
| Cellulose Polymers (CMC | Stable | 1-2 | 3 | 2 |
| and HPMC) | Solution | | | |
| Carrageenan | Stable | 1-2 | 3 | 2 |
| | Solution | | | |
| Pectins | Phase | 2 | 3 | 1 |
| | separation | | | |
| Alginates | Stable | 1-2 | 1 | 2 |
| | Solution | | | |

As shown in Table A and B, alginate and carageenan show particular good solution stability and good slacking stability. Alginate has a particularly good cooking stability. As shown in table B, the presence of a surfactant improves the flavor impact.

TABLE 4C

| Polymer formulations C | | | | |
|---|---|---|---|---|
| With Tween 80 | Solution | Slacking | Cooking | Flavor |
| and Glycerin | Stability | Stability | Stability | Impact |
| Modified Starches + | Phase | 2 | 3 | 1 |
| Maltodextrins | separation | | | |
| Tapiocca Dextrins + | Phase | 2 | 2 | 1 |
| Starches | separation | | | |
| Cellulose Polymers (CMC | Stable | 1 | 3 | 3 |
| and HPMC) | Solution | | | |
| Carrageenan | Stable | 1-2 | 3 | 2 |
| | Solution | | | |
| Pectins | Phase | 2 | 3 | 1 |
| | separation | | | |
| Alginates | Stable | 1 | 1 | 3 |
| | Solution | | | |

### Example 5

### Performance of Samples with Different Viscosity on Food Substrate

As food substrate, precooked processed chicken breast is used. Formulations containing various polymer concentrations of various viscosities are evaluated for slacking and cooking performance on substrate.

All alginate coating formulations are without flavor and contain 20% of a LMW Na Alginate (Manucol® LD), 7.5% of a film forming modified starch (Pure Coat 792), 5% of a surfactant (Polysorbat 80), 5% of a plasticizer (Glycerine), and different amounts of HMW alginate Protanal® (0%, 0.5%, 1%, or 2%) in water.

The glaze samples contain 25% of starch and modified starch (capsul® and Pure Coat 792 Modified Starch), or in addition 0.5% xanthan in water.

The frozen food substrate is removed from the freezer and weighed on a balance. The coating or glaze is applied and the food substrate is weighed. The food substrate is slacked for 3 hours in the refrigerator, and weighed after slacking. All weights are recorded. The food substrate is cooked on a Double Flame Broiler with a cooking dwell time of 2 minutes in the broiler. After cooking, the weights are measured and the percentages of weight loss are calculated as shown in example 3 above (results see table below).

TABLE 5A

| | Weight Loss | Weight Loss |
|---|---|---|
| | after Slacking | after Cooking |
| Samples in water | [%] | [%] |
| Control | 4.3 | 21.39 |
| 2% Protanal ® | 4 | 11.9 |
| 1% Protanal ® | 5.7 | 12.7 |
| 0.5% Protanal ® | 9.6 | 17.6 |
| 0% Protanal ® | 11.4 | 19.2 |

TABLE 5B

| | Weight Loss | Total Weight |
|---|---|---|
| | after | Loss after |
| Samples | Slacking [%] | cooking [%] |
| Control | 4.4 | 17.7 |
| 2% Protanal ® coating formulation | 4.05 | 13.97 |
| 1% Protanal ® coating formulation | 4.65 | 13.86 |
| 0.5% Protanal ® coating formulation | 6.99 | 17.67 |
| 0% Protanal ® coating formulation | 6.89 | 17.433 |
| capsul ®/Pure Coat 792 Modified Starch | 15.5 | 25.6 |
| Glaze | | |
| capsul ®/Pure Coat 792 Modified | 13.4 | 24 |
| Starch/.2% xanthan-Starch Glaze | | |

Formulations according to the invention have a better slacking stability, i.e. minimal to no loss of coating during slacking. Formulations with 1% and 2% HMW alginate (Protanal®) perform similar to the control with about 4% weight loss during the slacking process, i.e. there is a very good adherence of the applied coating. Even with only LMW alginate (0% Protanal®, 20% of a LMW Na Alginate (Manucol® LD) with about 7% weight loss the performance is still much better than that of conventional starch-based glazes that have a weight loss of 13-15%.

Formulations according to the invention also) have a better cooking stability, i.e. minimal to no loss of coating during cooking.

Weight loss during cooking is due to loss of water (compare control without any glaze, about 17%) and loss of applied coating or glaze.

Formulations with 1% and 2% Protanal® have less weight loss and retain more of the glaze and/or moisture during the cooking process as compared to the control. Formulations with 0.5% and 0% Protanal have a similarly low weight loss performance as the control during the cooking process. Starch based glazes have a higher weight loss during the cooking process compared both to control and to the, inventive alginate coating formulations.

### Example 6

### Coated Cereal Product in Milk

Coating Formulation for cereal according to the invention:

| | |
|---|---|
| De-ionized Water | 69.6 grams |
| Capsul ® Modified Starch | 10 grams |
| Pure Coat 792 Modified Starch | 8.5 grams |
| Sodium Alginate, Protanal ® RF-6650 | 0.4 grams |
| Sodium Alginate, Manucol ® LD | 4.0 grams |
| Pecan Praline Oil Soluble Flavor | 5.0 grams |
| (Givaudan Flavors, Cincinnati, USA) | |
| Glycerine | 2.0 grams |
| Bitter Blocker (Givaudan Flavors, Cincinnati, USA) | 0.5 grams |

### Cereal Samples and Preparation:

### 1. Flavored Corn Syrup or Sucrose Coated Cereal

Cereal product coated with 30% 70 Brix corn syrup or 70% sucrose (w/w) completely dissolved into warm water (120-150° C.). 0.813% Flavor (w/w) is added to the slurry and the flavored slurry is heated in the microwave for approximately 10 seconds to about 185-212° F.

### 2. Flavored Cereal Coated with the Inventive Alginate Formulation

21 grams of cereal is used with 15 g of slurry. The slurry is formed of an inventive coating formulation as indicated above. The flavored slurry is heated in the microwave for about 10-15 seconds to approximately 185-212° F. The flavored slurry is mixed with 21 grams of cereal. The mixture is dried in a convection oven at 200-250° F. for about 10-20 minutes. During drying, the mixture is stirred once or twice to prevent clumping.

Both products are exposed to milk at room temperature. The corn syrup coated cereal is soggy in milk after only 5 minutes, while the cereal with the inventive coating stays crunchy much longer and becomes soggy only after 30 minutes. Similar results are obtained for flavor migration into the milk (tested by tasting the milk without cereal flakes), which occurs in less than 5 minutes for corn syrup coated cereal and only after 30 minutes for the cereal coated with the inventive formulation.

1. Formulation comprising a polymer selected from the group consisting of alginate, carageenan, carboxymethlylcellulose, hydroxypropylmethylcellulose and combinations thereof in an amount from about 1% to 20%, optionally 2% to 10%, or 3% to 5%;
one or more surfactants in an amount in an amount of 0.1 to 10%, optionally 0.2 to 5%, 0.25 to 2.5%, or 0.5 to 1.5%; one or more flavor in a sufficient amount, and water;
optionally further comprising a plasticiser; and further optionally comprising starches and maltodextrins in an amount of less than 5%, optionally less than 2.5%, less than 1%, or less than 0.5%.

2. Formulation of claim 1 wherein the plasticiser is present in an amount of 0.1 to 10%, optionally 0.2 to 5%, 0.25 to 2.5%, or 0.5 to 1.5%.

3. Formulation of claim 2 wherein the plasticizer is selected from the group consisting of polyhydric alcohols, glycerine, polyethylene glycol, propylene glycol, sorbitol, maltitol, mannitol, and combinations thereof.

4. (canceled)

5. Formulation of claim 1 in dry form to provide a coating upon mixing with water.

6. Method of providing flavor to a food product by applying a liquid coating to said food product, wherein the liquid coating is a formulation as defined in claim 1.

7. Method of providing flavor to a food product by applying a liquid coating to said food product, wherein a dry coating formulation is dissolved into water to provide a liquid coating formulation as defined in claim 1.

8. Food product coated with the formulation of claim 1.

9. Coated food product according to claim 8 selected from meat products and cereal products.

10. Formulation comprising alginate in an amount from about 1% to 20%, optionally 2% to 10%, or 3% to 5%; one or more flavor in a sufficient amount, and water;
optionally further comprising one or more plasticizers; optionally further comprising an artificial sweetener; and further optionally comprising modified starches in an amount of 1% to 25%, or optionally 15% to 20%.

11. Formulation according to claim 10, wherein the one or more plasticizers are present in an amount of 0.1 to 10%, optionally 0.2 to 5%, 0.5 to 3%, or 1.5 to 2.5%.

12. Formulation according to claim 11 wherein the plasticizer is selected from polyhydric alcohol, glycerine, polyethylene glycol, propylene glycol, sorbitol, maltitol, mannitol, and combinations thereof.

13. (canceled)

14. Formulation according to claim 10, further comprising the artificial sweetener.

15. Formulation according to claim 14, wherein the artificial sweetener is selected from sucralose, saccharin, aspartame, cyclamate, and acesulfame.

16. Formulation of claim 10 dry form to provide a coating upon mixing with water.

17. Method of providing flavor to a dry food product by applying a liquid coating to said food product, wherein the liquid coating is a formulation as defined in claim 10.

18. Method of providing flavor to a dry food product by applying a liquid coating to said food product, wherein a dry coating formulation is dissolved into water to provide a liquid coating formulation as defined in claim 10.

19. Dry product coated with the formulation of claim 10.

20. Coated dry food product according to claim 19 selected from flaked food products, cereals, corn flakes, puffed corn, corn flakes, bran flakes, cheerios, and rice crispies.

21. Food product coated with the formulation of claim 3.

22. Dry product coated with the formulation of claim 12.
